(19) United States
(12) Patent Application Publication
(10) Pub. No.: US 2020/0296930 A1
(43) Pub. Date: Sep. 24, 2020

(54) ELASTICIZED PET FOOTWEAR ARTICLE

(71) Applicant: DOG E LITES INC., St-Laurent (CA)

(72) Inventor: Robin Whyte, St-Laurent (CA)

(21) Appl. No.: 16/824,118

(22) Filed: Mar. 19, 2020

Related U.S. Application Data
(60) Provisional application No. 62/820,533, filed on Mar. 19, 2019.

(51) Int. Cl. A01K 13/00

(52) U.S. Cl. CPC A01K 13/007

(57) ABSTRACT

A pet footwear article includes a sole and an upper. The upper is formed at least partly of fabric and having a top edge defining a top opening for receiving a paw of a pet and a lower edge being joined to the sole. A set of elastics bands extend laterally about the upper and provides a compressive force to the upper. The stretchable upper can promote a snug fit of the upper about the paw of the pet. The upper can have a vamp portion and a shaft portion, both of which are stretchable.

### RELATED PATENT APPLICATION

The present application claims priority from U.S. provisional patent application No. 62/820,533, filed Mar. 19, 2019 and entitled “ELASTICIZED PET FOOTWEAR ARTICLE”, the disclosure of which is hereby incorporated by reference in its entirety.

### TECHNICAL FIELD

The present disclosure generally relates to a pet footwear article, and more particularly, to a pet footwear article having a plurality of elastic bands extending laterally about the upper and configured to provide a compressive force of the upper of the footwear article.

### BACKGROUND

In the field of pet accessories, footwear for pets is a popular item, especially for pet dogs. The footwear is worn over the paws of the pet to provide protection to the paws, such as from dirt and debris, abrasive surfaces and/or cold surfaces in colder climates.

Various currently available footwear articles for pets do not provide a proper fit when worn on the paws of a pet due to the wide variety of paw shapes and sizes. Accordingly, such currently available footwear article for pets have a high chance of falling off when worn (ex: due to a loose fit) and/or can cause discomfort to the pet (ex: due to overly tight fit).

### SUMMARY

According to one aspect, there is provided a pet footwear article comprising a sole, an upper formed at least partly of fabric and having a top edge defining a top opening for receiving a paw of a pet and a lower edge being joined to the soles and a set of a plurality of elastic bands extending laterally about the upper and configured to provide a compressive force to the upper.

According to another aspect, there is provided a method or causing a pet to wear a pet footwear article. The method includes providing the pet footwear article, the pet footwear article having a sole, an upper formed at least partly of fabric and having a vamp portion and a shaft portion, the vamp portion having a lower edge being joined to the sole and the shaft portion extending upwardly from the vamp portion and having a top opening, a frontal opening and a fastener mechanism for selectively closing the frontal opening, the pet footwear article further having a plurality of elastic bands extending laterally about the upper; unfastening the fastener mechanism to cause opening of the frontal opening of the shaft portion; inserting the paw of the pet into the pet footwear article via the top opening and the frontal opening of the shaft portion, whereby the paw is supported on the sole; and fastening the fastener mechanism to cause closing of the frontal opening, whereby the elastic bands extend in their stretched state about the paw and a leg of the pet to provide a compressive force onto the paw and the leg.

According to an example embodiment, the set of elastic bands are sewn onto an inner surface of the upper.

According to an example embodiment, the set of elastic bands are sewn with a zigzag stitching pattern.

According to an example embodiment, the sewing of the set of elastic bands to the upper causes a shirring to the fabric.

According to an example embodiment, the upper comprises a vamp portion and a shaft portion, the vamp portion having the lower edge and being joined to the sole and the shaft portion extending upwardly from the vamp portion to the top opening.

According to an example embodiment, the vamp portion is sized and shaped to provide a snug fit to the paw of the pet and wherein the shaft portion is sized and shaped to provide a snug fit about a lower leg region of the pet

According to an example embodiment, the vamp portion and the shaft portion of the upper is formed of a monolithic piece of fabric.

According to an example embodiment, a first subset of the set of elastic bands extend circumferentially about the shaft portion and a second subset of one or more elastic bands of the set of elastic bands extend along the vamp portion.

According to an example embodiment, each of the elastic bands of the first subset are oriented parallelly to the top opening.

According to an example embodiment, the second subset of one or more elastic bands overlaps with the sole.

According to an example embodiment, the one or more elastic bands of the second subset each have an end terminating at the sole.

According to an example embodiment, the shaft portion comprises first and second frontal edges defining a frontal opening extending from the top edge of the upper along a front of the shaft portion to the vamp portion and a fastener mechanism configured for selectively closing the frontal opening.

According to an example embodiment, the fastener mechanism is a hook and loop fastener extending along the first and second frontal edges of the frontal opening of the shaft portion of the upper.

According to an example embodiment, the first subset of elastic bands comprises a plurality of rows of elastic bands each extending from the first frontal edge along a circumference of the shaft to the second frontal edge.

According to an example embodiment, the each of the one or more elastic bands of the second subset extend from a lower end of the frontal opening of the shaft portion to the sole.

According to an example embodiment, a height of the shaft portion is adjustable by cutting a top portion of the shaft portion, wherein a finish of the top edge of the shaft portion prior to the cutting and a finish of the top edge of the shaft portion after the cutting is substantially the same.

According to an example embodiment, the fabric of the upper is a stretch fabric.

According to an example embodiment, prior to inserting the paw into the pet footwear article, cutting a top portion of the shaft portion to adjust a height of the shaft portion in accordance with a length of the leg of the pet.

### BRIEF DESCRIPTION OF THE DRAWINGS

For a better understanding of the embodiments described herein and to show more clearly how they may be carried into effect, reference will now be made, by way of example only, to the accompanying drawings which show at least one exemplary embodiment, and in which:

FIG. 1A is a front elevation view of a pet footwear article according to an example embodiment;

FIG. 1B is a front elevation view of the pet footwear article according to one example embodiment;

FIG. 2 is a front elevation view of the pet footwear article with an open frontal opening according to one example embodiment;

FIG. 3 is a first side elevation view of the pet footwear article according to one example embodiment;

FIG. 4 is a rear elevation view of the pet footwear article according to one example embodiment;

FIG. 5 is a top view of the pet footwear article according to one example embodiment;

FIG. 6 is a bottom view of the pet footwear article according to one example embodiment;

FIG. 7 is a blank of the upper of the pet footwear article according to one example embodiment;

FIG. 8 is a front perspective view of the pet footwear article according to one example embodiment;

FIG. 9 is a rear perspective view of the pet footwear article according to one example embodiment.

It will be appreciated that for simplicity and clarity of illustration, elements shown in the figures have not necessarily been drawn to scale. For example, the dimensions of some of the elements may be exaggerated relative to other elements for clarity.

### DETAILED DESCRIPTION

It will be appreciated that, for simplicity and clarity of illustration, where considered appropriate, reference numerals may be repeated among the figures to indicate corresponding or analogous elements or steps. In addition, numerous specific details are set forth in order to provide a thorough understanding of the exemplary embodiments described herein. However, it will be understood by those of ordinary skill in the art, that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way but rather as merely describing the implementation of the various embodiments described herein.

It was observed that pets, especially dogs, have diverse paw shapes, leg shapes and leg height. This diversity is caused by variety in breed, genetics, age and lifestyle (ex: life history). Additionally, it was observed that nail length and shape can significantly impact the paw print, thereby also affecting the space required within a footwear article for covering the paw.

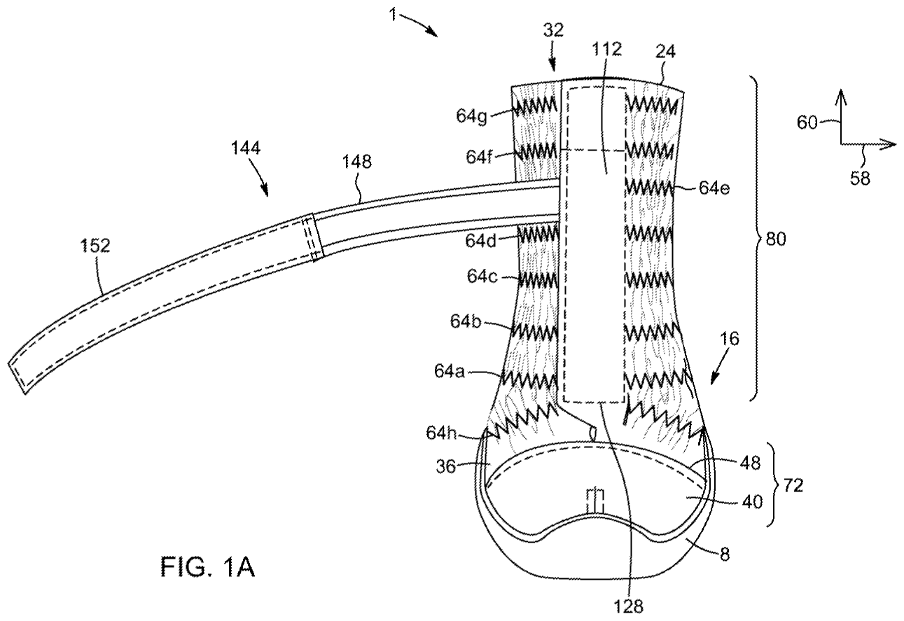

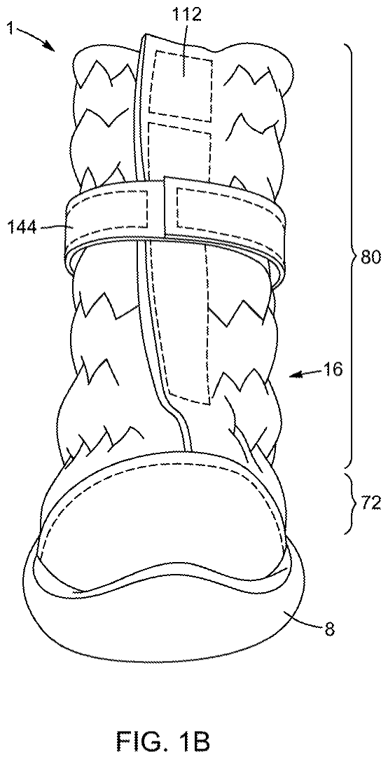

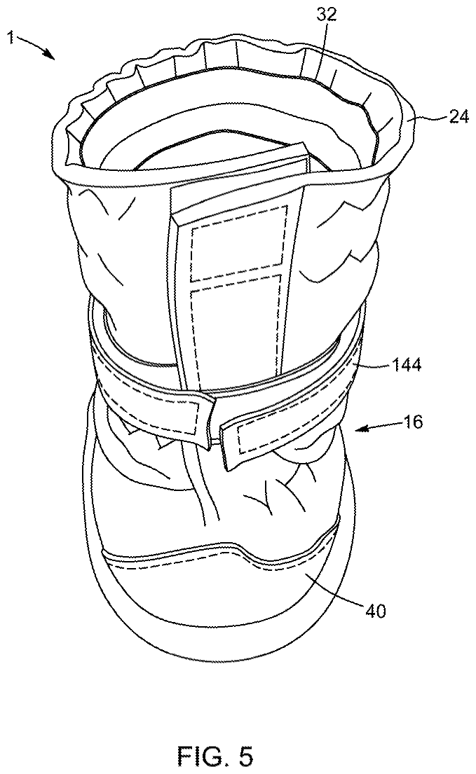

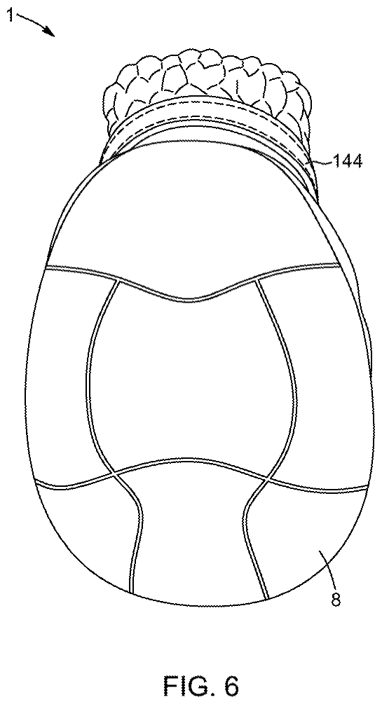

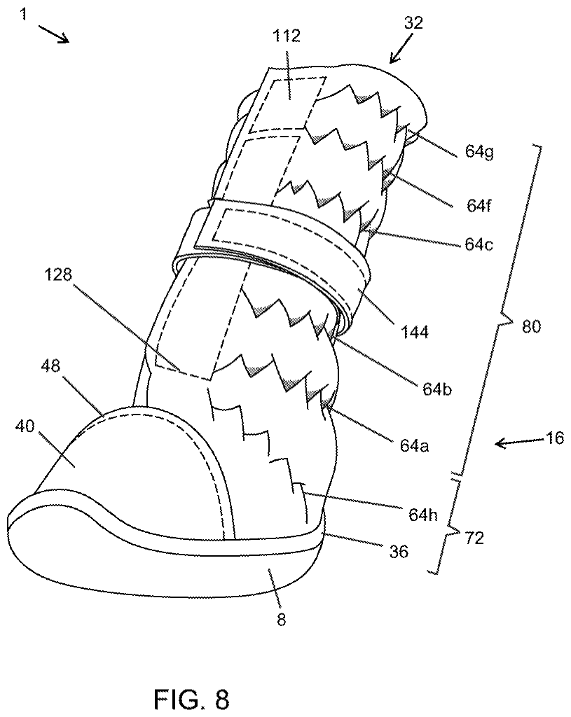

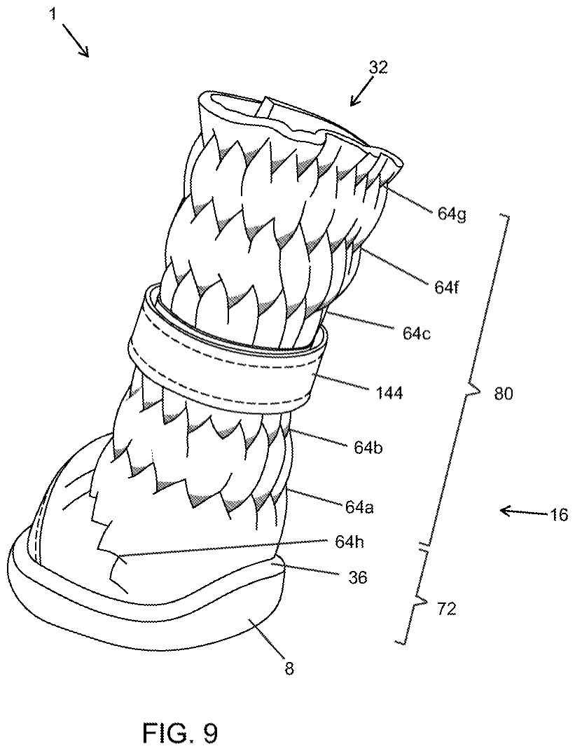

FIGS. 1A to 6, 8, and 9 illustrate various views of a pet footwear article 1 according an example embodiment the pet footwear article 1. The pet footwear article 1 includes a sole 8 and an upper 16. The sole 8 can be formed of a material that provides grip (ex: frictional engagement) when engaging a ground surface. The sole 8 can be formed of polyvinyl chloride. A front of the sole and the rear of the sole can be raised to provide protection and stability.

The upper 16 is formed partly of a flexible fabric. In various example embodiments, the fabric can be stretch fabric having some elasticity to permit expansion of the upper 16. The fabric can be a synthetic material, such as neoprene or an equivalent fabric. The upper 16 further has a top edge 24 defining a top opening 32 for receiving a paw of a pet. The upper 16 further has a lower edge 36 that is joined to the sole 8. The lower edge 36 can be joined to the outer edges of the sole 8 according to methods commonly known in the art (ex: using an appropriate adhesive) to form a housing for receiving the paw of the pet. The joint between the upper 16 and the sole 8 can provide a waterproof seal.

According to some example embodiments, and illustrated in FIG. 1, the upper 16 of the pet footwear article 1 can include a toe cap portion 40 formed of a sturdy, non-elastic material. The top cap portion 40 can be formed of polyurethane. As illustrated, an edge of the portion of the upper 16 formed of the fabric is joined to an edge of the top cap portion 40, such as by stitching 48 along the two edges. The lower edge of the top cap portion 40 is joined to the outer edges of the sole 8 along a frontal region of the sole 8.

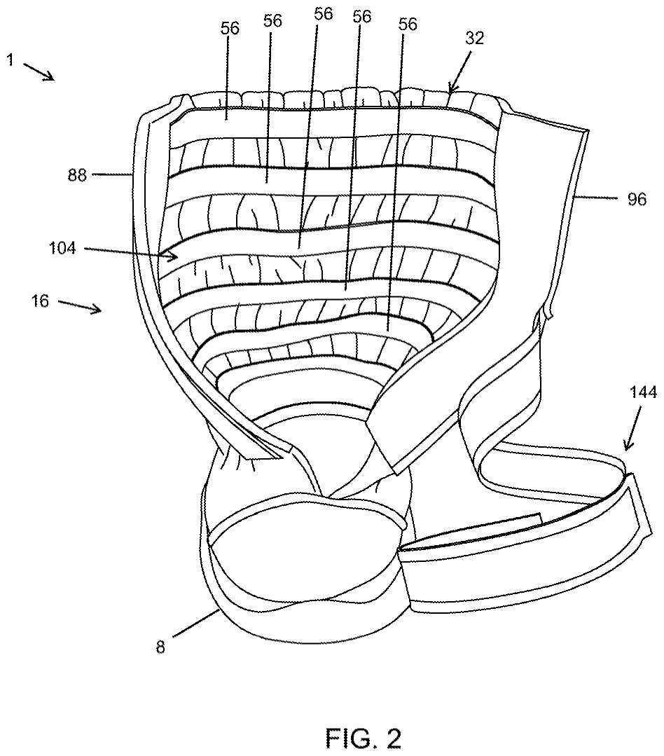

The pet footwear article 1 further includes a set of a plurality of elastic bands 56 (FIG. 2) extending laterally along the upper 16. The elastic bands 56 have a stiffness that is greater than the stiffness of the fabric (ex: stretch fabric) forming the upper 16. Accordingly, the elastic bands 56 provide a compressive force when stretched that is greater than the compressive force by the material of the upper 16.

The lateral direction corresponds generally to a direction 58 that is aligned with the sole 8 or the ground onto which the pet footwear article 1 will be supported when in use. A heightwise direction 60 is transverse to the lateral direction and corresponds generally to the direction of the leg of the pet wearing the pet footwear article 1 when in use. It will be understood that while the elastic bands 56 are oriented laterally along the upper 16, some of the elastic bands can also have a component of orientation in the heightwise direction 60.

According to one example embodiment, and as illustrated, the elastic bands 56 are sewn to the fabric of the upper 16. As illustrated in FIG. 2, the elastics bands may be sewn onto the inner surface of the upper 16. The sewing can be carried out using a zigzag stitching pattern (64a, 64b 64c. . . ) to permit lateral stretching of the fabric of the upper 16. The sewing further causes the fabric of the upper 16 to have shirring in regions corresponding to the zigzag stitching.

According to one example embodiment, and as illustrated in the figures, the upper 16 has a vamp portion 72 and a shaft portion 80. The lower edge 36 of the upper 16 is located in the vamp portion 72. Accordingly, the vamp portion 72 of the upper 16 is joined to the sole 8. The shaft portion 80 extends upwardly from the vamp portion 72. The top edge 24 of the upper and the top opening 32 are found in the shaft portion 80.

When the pet footwear article 1 is properly worn, the vamp portion 72 covers the paw of the pet and the shaft portion 80 covers a lower region of the leg of the pet. Due to the elasticity of the set of the elastic bands 56 extending laterally about the upper 16 to provide the compressive force, the vamp portion 72 is sized and shaped to provide a snug fit to the paw of the pet and the shaft portion 80 is sized and shaped to provide a snug fit to the lower leg region of the leg. It will be understood that the snug fit is provided where an appropriate size (ex: from sizes 2XS to 3XL) is selected for a given pet. It will be understood that the design is applicable for a variety of sizes, and can include sizes smaller than 2XS or larger than 3XL.

According to one example embodiment, and as illustrated, the vamp portion 72 and the shaft portion 80 are formed of a monolithic piece of fabric. It will be understood that the piece of fabric being monolithic means that a single piece of fabric is used to form both the vamp portion 72 and the shaft portion 80 and that the two portions 72, 80 are not formed from joining together two previously discrete pieces of fabric.

The set of the plurality of elastic bands 56 are distributed over both the vamp portion 72 and the shaft portion 80. According to one example embodiment, and as illustrated, the set of elastic bands 56 includes a first subset of elastic bands located along the shaft portion 80 and a second subset of one or more elastic bands located along the vamp portion 72. In the example illustrated in the FIGS. 1A, 3, 4, and 7, the exemplary pet footwear article 1 is denoted to be a “medium” size and the first subset of elastic bands consists of 7 rows of elastic bands 56 (corresponding to zigzag rows 64a, 64b, 64c, 64d, 64e, 64f and 64g). In the same figures, the second subset of elastic bands consists of a single row of elastic bands 56 (corresponding to zigzag row 64h).

In the examples shown in the pet footwear article of FIGS. 1B, 2, 3, 4, 5, 6, 8, and 9 the first subset of elastic bands 56 (as represented by zigzag stitching 64a, 64b, 64c, . . . ) located on the shaft portion 80 consists of 6 rows of elastic bands 56 and the second subset of elastic bands consists of a single row of elastic bands 56. Accordingly, the pet footwear article shown in the FIGS. 1B, 2, 3, 4, 5 and 6 can correspond to another size (ex: size “small”) of the pet footwear article 1 or that the height of the shaft portion 80 has been adjusted, as described elsewhere herein.

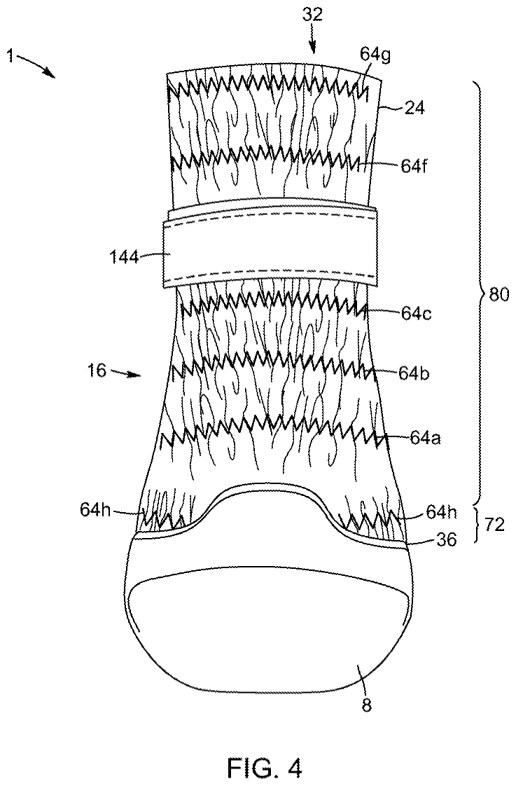

The shaft portion 80 has a generally tubular shape for receiving the lower leg region of a pet. The first subset of the set of elastic bands 56 located on the shaft portion extend laterally and circumferentially about the shaft portion 80. That is, each elastic band 56 of the first subset extend around the tubular shape of the shaft portion 80 while maintaining a substantially constant heightwise position along the shaft portion 80. As illustrated FIG. 4, the elastic bands 56 (as represented by zigzag stitching 64a, 64b, 64c, . . . ) of the first subset extend over a back of the shaft portion 80 of the upper 16. For example, and as illustrated, the elastic bands 56 of the first subset are oriented to be substantially parallel with one another. The elastic bands 56 of the first subset can also be oriented to be substantially parallel with the top edge of the upper 16 defining the top opening 32.

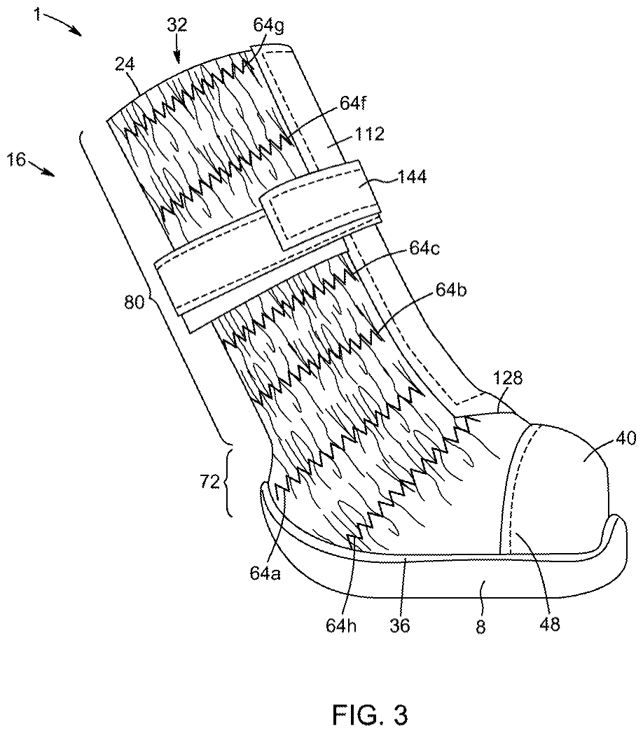

The second subset of one or more elastic bands 56 extends about the vamp portion 72. For example, and as illustrated, the second subset of one or more elastic bands 56 is located on the vamp portion 72 at a position that overlaps with where the vamp portion 72 is joined to the sole 8. As shown in FIG. 3, a row of elastic bands of the second subset (as represented by zig zag stitching 64h) extends to terminate at the sole 8. Each of the elastic bands of the second subset can have an end that terminates at the sole 8.

With continued reference to the FIGS. 1A to 6, 8, and 9 and as best seen in FIG. 2, the shaft portion 80 of the upper 16 has first and second frontal edges 88, 96 that extend in a heightwise direction 60 of the shaft portion 80. The frontal edges 88, 96 define a frontal opening 104. As best seen in FIG. 2, the frontal opening 104 is a continuation of the top opening 32 and extends from the top edge 24 of the upper 16 along a front of the shaft portion 80. The frontal opening 104 can extend to the vamp portion 72. In some embodiments, the frontal opening 104 can also extend into the vamp portion 72.

The shaft portion 80 further includes a fastener mechanism 112 for selectively closing the frontal opening 104. FIGS. 1A, 1B, 3, 5, and 8 show the fastener mechanism 112 in a closed position to close the frontal opening 104.

In the illustrated example, the fastener mechanism 112 is a hook and loop fastener extending along the first and second frontal edges 88 and 96 of the shaft portion 80 of the upper 16. As shown in FIG. 2, the hook portion of the fastener mechanism 112 extends along the first frontal edge 88 and the loop portion of the fastener mechanism 112 extends along the second frontal edge 96.

The opening of the frontal opening 104 provides a greater clearance (in combination with top opening 32) for receiving the paw and lower leg region of a pet into the pet footwear article 1. The closing of the frontal opening 104 and the securing of the fastener mechanism 112 ensures a snug fit of the vamp portion 72 and shaft portion 80 of the pet footwear article 1 about the paw and lower leg region of the pet.

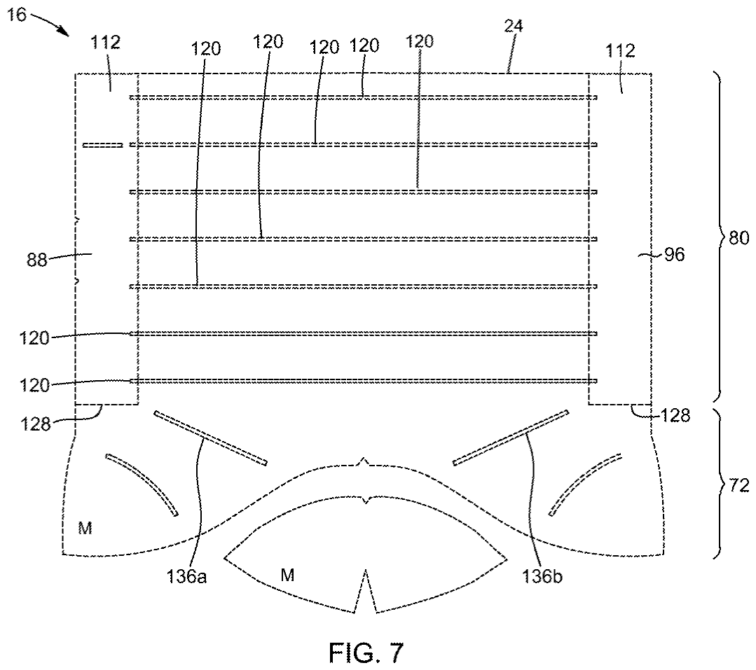

In one example exemplary embodiment, the first subset of elastic bands that are located on the shaft portion 80 each extends from the first frontal edge 88 of the frontal portion along the circumference (ex: around the sides and back of the shaft portion) to reach the second frontal edge 96. Referring now to FIG. 7, therein illustrated is a blank for forming the upper 16. Pattern lines 120 indicate where elastic bands 56 are to be sewn onto the inner surface of the upper 16. It will be appreciated that 7 parallel lines 120 extending from first front edge 88 to second frontal edge 96 represent where elastic bands 56 of the first subset are to be sewn.

Where the shaft portion 80 includes the frontal opening 104, the second subset of one or more elastic bands 56 extend from a lower end 128 of the frontal opening 104 of the shaft portion 80 to the sole 8 of the pet footwear article 1. The elastic bands of the second subset can include two elastic bands 56 each extending downwardly from the lower end 128 of the frontal opening 104 towards either sides (i.e. left and right sides) of the sole 8. Referring back to FIG. 7, a first diagonally oriented pattern line 136a indicates where a first of the elastic bands of the second subset is to be sewn and a second diagonally oriented pattern line 136b indicates where a second of the elastic bands of the second subset is to be sewn.

According to various exemplary embodiments, and as illustrated herein, the pet footwear article 1 further includes a securing member 144 located at an intermediate heightwise position along the height of the shaft portion 8 of the upper. The securing member 144 is configured to wrap around the circumference of the tubular shape of the shaft portion 80 to fasten onto itself. In the illustrated example, the securing member 144 is an elongated strap having a first hook portion 148 that extends into a second loop portion 152. In use, the strap 144 is wrapped around the shaft portion 80 whereby the second loop portion 152 secures onto the first hook portion 148. The amount of overlapping of the hook portion 148 and loop portion 152 determines the effective circumference of the securing member 144 and thereby the fit of the strap around the lower leg region of the pet received within the shaft portion 80.

According to various exemplary embodiments, the height of the shaft portion 80 can optionally be adjusted to improve the fit of the pet footwear article 1 for a given pet. The height of the shaft portion 80 can be adjusted by cutting a top portion of the shaft portion 80 near the top edge 24. It will be appreciated the height of shaft portion 80 can be adjusted to any height between i) the height of the shaft portion 80 of the pet footwear article 1 as manufactured and sold and ii) the height of the securing member 144, by making the cut at the desired height. Accordingly, the fabric forming the shaft portion 80 is selected to permit the cutting using a standard cutting tool (ex: household scissors). The fabric can be cut without fraying or ripping. More generally, the finish of the top edge 24 of the upper 16 prior to the cutting (i.e. as manufactured and sold) is substantially the same as the finish of the new top edge of the upper 16 after the cutting to adjust the height. However, it will be understood that in other embodiments the pet footwear article 1 is ready for use as manufacturer and is not intended to be adjustable from cutting of the shaft portion 80.

According to a method for causing a pet to wear the pet footwear article 1, one or more units of the pet footwear article 1 as described herein is provided. Typically, four units will be used (ex: 1 for each paw of a dog), but other number of units can also be used (ex: 2 units for front paws only or hind paws only). The pet footwear article 1 can be available in different sizes and the size appropriate for the given pet is selected. For example, the appropriate size can be determined by selecting a size of the footwear article 1 that has a vamp portion 72 and sole 8 that provides the closest match to the paw size of the given animal.

Where necessary, the height of the shaft portion 80 of the upper 16 can be adjusted by cutting a top portion of the shaft portion 80. The height of the cut can be selected based on the length of the leg of the pet. It will be appreciated that this cut can be effective for providing a better fit of the footwear article 1 to the given pet. It will be appreciated that different breeds of pets (ex: dogs) can have similar paw sizes but different leg lengths, thereby requiring the adjustment of the height of the pet footwear article 1.

The method further includes unfastening the fastener mechanism 112 to cause opening of the frontal opening 104 of the shaft portion 80. The paw of the pet is inserted through the clearance provided by the top opening 32 and the frontal opening 104 so that the paw is supported on the sole 8. After inserting the paw, the shaft portion 80 is wrapped around the lower leg region of the pet and the fastener mechanism 112 is fastened to cause closing of the frontal opening 104 of the shaft portion 80. The securing member 144 can also be fastened according to the size of the lower leg region of the pet.

It will be appreciated that closing the fastener mechanism 112 can cause the elastic bands to extend into their stretched state about the paw and lower leg region of the pet, thereby to provide a compressive force on the paw and the leg. This stretching can promote a snug fit of the vamp portion 72 about the paw of the pet (from stretching of the second subset of one or more elastic bands 56) and a snug fit of the shaft portion about the lower leg region (from stretching of the first subset of elastic bands 56).

While the above description provides examples of the embodiments, it will be appreciated that some features and/or functions of the described embodiments are susceptible to modification without departing from the spirit and principles of operation of the described embodiments. Accordingly, what has been described above has been intended to be illustrative and non-limiting and it will be understood by persons skilled in the art that other variants and modifications may be made without departing from the scope of the invention as defined in the claims appended hereto.

1. A pet footwear article comprising:
a sole;
an upper formed at least partly of fabric and having a top edge defining a top opening for receiving a paw of a pet and a lower edge being joined to the sole; and
a set of a plurality of elastic bands extending laterally about the upper and configured to provide a compressive force to the upper.

2. The pet footwear article of claim 1, wherein the set of elastic bands are sewn onto an inner surface of the upper.

3. The pet footwear article of claim 2, wherein the set of elastic bands are sewn with a zigzag stitching pattern.

4. The pet footwear article of claim 3, wherein the sewing of the set of elastic bands to the upper causes a shirring to the fabric.

5. The pet footwear article of claim 1, wherein the upper comprises a vamp portion and a shaft portion, the vamp portion having the lower edge and being joined to the sole and the shaft portion extending upwardly from the vamp portion to the top opening.

6. The pet footwear article of claim 5, wherein the vamp portion is sized and shaped to provide a snug fit to the paw of the pet and wherein the shaft portion is sized and shaped to provide a snug fit about a lower leg region of the pet.

7. The pet footwear article of claim 6, wherein the vamp portion and the shaft portion of the upper is formed of a monolithic piece of fabric.

8. The pet footwear article of claim 5, wherein a first subset of the set of elastic bands extend circumferentially about the shaft portion; and
wherein a second subset of one or more elastic bands of the set of elastic bands extend along the vamp portion.

9. The pet footwear article of claim 8, wherein each of the elastic bands of the first subset are oriented parallelly to the top opening.

10. The pet footwear article of claims 8, wherein the second subset of one or more elastic bands overlaps with the sole.

11. The pet footwear article of claim 8, wherein the one or more elastic bands of the second subset each have an end terminating at the sole.

12. The pet footwear article of claim 8, wherein the shaft portion comprises:
first and second frontal edges defining a frontal opening extending from the top edge of the upper along a front of the shaft portion to the vamp portion; and
a fastener mechanism configured for selectively closing the frontal opening.

13. The pet footwear article of claim 12, wherein the fastener mechanism is a hook and loop fastener extending along the first and second frontal edges of the frontal opening of the shaft portion of the upper.

14. The pet footwear article of claim 8, wherein the first subset of elastic bands comprises a plurality of rows of elastic bands each extending from the first frontal edge along a circumference of the shaft to the second frontal edge.

15. The pet footwear article of claim 8, wherein the each of the one or more elastic bands of the second subset extend from a lower end of the frontal opening of the shaft portion to the sole.

16. The pet footwear article of claim 5, wherein a height of the shaft portion is adjustable by cutting a top portion of the shaft portion, wherein a finish of the top edge of the shaft portion prior to the cutting and a finish of the top edge of the shaft portion after the cutting is substantially the same.

17. The pet footwear of claim 1, wherein the fabric of the upper is a stretch fabric.

18. A method for causing a pet to wear a pet footwear article, the method comprising;
providing the pet footwear article, the pet footwear article having a sole, an upper formed at least partly of fabric and having a vamp portion and a shaft portion, the vamp portion having a lower edge being joined to the sole and the shaft portion extending upwardly from the vamp portion and having a top opening, a frontal opening and a fastener mechanism for selectively closing the frontal opening, the pet footwear article further having a plurality of elastic bands extending laterally about the upper;
unfastening the fastener mechanism to cause opening of the frontal opening of the shaft portion;
inserting the paw of the pet into the pet footwear article via the top opening and the frontal opening of the shaft portion, whereby the paw is supported on the sole; and
fastening the fastener mechanism to cause closing of the frontal opening, whereby the elastic bands extend in their stretched state about the paw and a leg of the pet to provide a compressive force onto the paw and the leg.

19. The method of claim 18, further comprising:
prior to inserting the paw into the pet footwear article, cutting a top portion of the shaft portion to adjust a height of the shaft portion in accordance with a length of the leg of the pet.
